(19) United States
(12) Patent Application Publication
(10) Pub. No.: US 2026/0125990 A1
(43) Pub. Date: May 7, 2026

(54) EXPANSION JOINT FOR GAS TURBINE EXHAUST SYSTEM

(71) Applicant: GE Infrastructure Technology LLC, Greenville, SC (US)

(72) Inventors: Javeed Iqbaluddin Mohammed, Bangalore (IN); Bradly Aaron Kippel, Greenville, SC (US)

(21) Appl. No.: 18/934,423

(22) Filed: Nov. 1, 2024

(51) Int. Cl. F01D 25/24

(52) U.S. Cl. CPC F01D 25/243

(57) ABSTRACT

An expansion joint for a gas turbine exhaust system includes arcuate expansion joint segments that include a rigid seal plate having an inner radial end and an outer radial end. A first pivot coupler pivotally couples the inner radial end of the rigid seal plate to the turbine duct flange, and a second pivot coupler pivotally couples the outer radial end of the rigid seal plate to the diffuser duct flange. The pivot couplers include a mount member fixedly coupled to a respective duct flange and pivotally engaging a first axial side of the rigid seal plate, a clamp member pivotally engaging a second axial side of the rigid seal plate opposite the first axial side of the rigid seal plate, and actuator(s) configured to press a respective radial end of the rigid seal plate between the clamp member and the mount member.

### TECHNICAL FIELD

The disclosure relates generally to expansion joints. More specifically, the disclosure relates to an expansion joint for a gas turbine exhaust system.

### BACKGROUND

Gas turbine (GT) systems, as used for electrical power generation, typically include a compressor section, a combustion section that generates hot combustion gases from fuel and air from the compressor section, a turbine section that expands the hot combustion gases to produce work, and an exhaust section that conveys the energy-depleted gases from the GT system. A diffuser duct is commonly positioned between the turbine section and the exhaust section. The diffuser duct provides performance benefits to the GT system as a whole by expanding the exhaust gases to achieve optimum aerodynamic pressure recovery. The diffuser duct may have two parts, such as a forward part that is externally insulated and an aft part that is internally insulated.

An expansion joint may be used to join the forward and aft parts of the diffuser duct, as well as connecting the turbine duct flange and the diffuser duct flange. Most turbine ducts run hot and are machined structures, while most diffuser ducts are lower cost fabricated casings that are internally insulated and relatively cold. The thermal mismatch at this connection requires an expansion joint to accommodate the large relative displacements between these components.

The expansion joints must be able to accommodate large axial, vertical, and lateral movements. One approach to providing an expansion joint uses a vertically mounted flexible element coupled between the turbine duct aft flange and the diffuser duct forward flange. A vertical offset between the flanges provides a location to attach each end of the flexible vertical element. This approach presents a number of challenges. For example, higher temperature exhaust is becoming more common with the increased use of hydrogen fuel. The flexible elements must be made of highly flexible material, such as superalloys made from nickel with chromium, iron, and other metals like cobalt, manganese, copper, niobium, and tantalum (e.g., INCONEL® materials), but they are unable to withstand higher temperature exhaust, e.g., higher than 650° C. (˜1200°F). Unfortunately, conventional flexible element expansion joints may not withstand the higher back-pressures of current downstream emissions reduction systems. The flexible elements also must be carefully coupled using complex mounting systems to prevent wear and to ensure proper operation, which increases the complexity of assembly and maintenance. The flexible elements also require a separate collection trough to capture water from turbine water washes that may enter expansion joint insulation and otherwise flow out onto the ground.

### BRIEF DESCRIPTION

All aspects, examples and features mentioned below can be combined in any technically possible way.

An aspect of the disclosure provides an expansion joint for use between a turbine duct flange and a diffuser duct flange of a gas turbine exhaust system, the expansion joint comprising: a plurality of arcuate expansion joint segments configured to be arranged circumferentially to collectively form an annular expansion joint assembly, the plurality of arcuate expansion joint segments each including: a rigid seal plate having an inner radial end and an outer radial end; a first pivot coupler pivotally coupling the inner radial end to the turbine duct flange; and a second pivot coupler pivotally coupling the outer radial end to the diffuser duct flange, wherein each of the first and second pivot couplers includes: a mount member fixedly coupled to a respective duct flange and pivotally engaging the rigid seal plate; a clamp member pivotally engaging the rigid seal plate; and at least one actuator configured to press a respective radial end of the rigid seal plate between the clamp member and the mount member.

Another aspect of the disclosure includes any of the preceding aspects, and the at least one actuator includes: a post fixedly coupled at one end thereof to a respective duct flange and extending through a first opening in the mount member, a second opening in a respective radial end of the rigid seal plate, and a third opening in the clamp member; a force applicator operatively coupled to the post; and a holder coupled to the post and engaging the force applicator, wherein the force applicator forces the clamp member and the respective radial end of the rigid seal plate against the mount member.

Another aspect of the disclosure includes any of the preceding aspects, and the second opening in the inner radial end of the rigid seal plate includes a through-hole extending through the rigid seal plate, and the second opening in the outer radial end of the rigid seal plate includes a slot extending through the rigid seal plate and open to a radial outer edge of the rigid seal plate.

Another aspect of the disclosure includes any of the preceding aspects, and further comprising at least one post-interface seal plate engaging an axial side of the rigid seal plate between the rigid seal plate and one of the mount member and the clamp member adjacent the second opening at a respective radial end of the rigid seal plate, the at least one post-interface seal plate including at least one third opening through which a respective post extends, wherein the at least one third opening is smaller than the second opening adjacent thereto in the rigid seal plate.

Another aspect of the disclosure includes any of the preceding aspects, and the at least one post-interface seal plate includes: a first pair of post-interface seal plates at the outer radial end of the rigid seal plate, the first pair of post-interface seal plates including a first post-interface seal plate engaging a first axial side of the rigid seal plate between the rigid seal plate and the mount member and a second post-interface seal plate engaging a second axial side of the rigid seal plate between the rigid seal plate and the clamp member; a second pair of post-interface seal plates at the inner radial end of the rigid seal plate, the second pair of post-interface seal plates including a third post-interface seal plate engaging the second axial side of the rigid seal plate between the rigid seal plate and the mount member and a fourth post-interface seal plate engaging the first axial side of the rigid seal plate between the rigid seal plate and the clamp member; or both the first pair of post-interface seal plates and the second pair of post-interface seal plates.

Another aspect of the disclosure includes any of the preceding aspects, and the rigid seal plate includes opposing circumferential ends configured to mate with an adjacent rigid seal plate of an adjacent arcuate expansion joint segment, and further comprises at least one segment end interface seal plate extending across a gap extending from the outer radial end to the inner radial end at adjacent circumferential ends of arcuately adjacent rigid seal plates, each segment end interface seal plate engaging an axial side of the arcuately adjacent rigid seal plates and including at least one third opening through which a respective post extends, wherein the third opening is smaller than the second opening adjacent thereto in the rigid seal plate.

Another aspect of the disclosure includes any of the preceding aspects, and circumferential ends of the at least one segment end interface seal plate and circumferential ends of the at least one post-interface seal plates include mating male-female couplers.

Another aspect of the disclosure includes any of the preceding aspects, and the force applicator includes a compression spring selected from a group comprising a coil spring and a cone frustum spring.

Another aspect of the disclosure includes any of the preceding aspects, and the post is outwardly threaded along at least a portion thereof, and the holder is threadedly adjustably coupled to the at least portion of the post.

Another aspect of the disclosure includes any of the preceding aspects, and in a cold operating state of the gas turbine exhaust system, the inner radial end of the rigid seal plate is axially forward of the outer radial end of the rigid seal plate, and in a hot operating state of the gas turbine exhaust system the inner radial end of the rigid seal plate is axially rearward of the outer radial end of the rigid seal plate.

Another aspect of the disclosure includes any of the preceding aspects, and the mount member and the clamp member are both substantially hemispherical.

Another aspect of the disclosure includes any of the preceding aspects, and the mount member and the clamp member are halves of a cylindrical pipe.

Another aspect of the disclosure includes any of the preceding aspects, and the rigid seal plate includes a male-female coupler on circumferential ends thereof configured to mate with a circumferentially adjacent rigid seal plate.

Another aspect of the disclosure includes any of the preceding aspects, and further comprising a wire mesh seal member filling a gap between an adjacent duct flange, the clamp member, and the mount member.

Another aspect of the disclosure includes any of the preceding aspects, and the rigid seal plate, the clamp member, and the mount member include a stainless steel.

Another aspect of the disclosure includes an expansion joint for use between a turbine duct flange and a diffuser duct flange of a gas turbine exhaust system, the expansion joint comprising: a plurality of arcuate expansion joint segments configured to be arranged collectively to form an annular expansion joint assembly, each arcuate expansion joint segment including: a rigid seal plate having an inner radial end, an outer radial end, a through-hole extending through the inner radial end of the rigid seal plate, and a slot extending through the outer radial end of the rigid seal plate and open to a radial outer edge of the rigid seal plate; a first pivot coupler pivotally coupling the inner radial end of the rigid seal plate to the turbine duct flange, the first pivot coupler including: a first mount member fixedly coupled to the turbine duct flange and pivotally engaging a first axial side of the rigid seal plate, a first clamp member pivotally engaging a second axial side of the rigid seal plate opposite the first axial side of the rigid seal plate, and at least one first actuator including: a first post fixedly coupled at one end thereof to the turbine duct flange and extending through a first opening in the first mount member, the through-hole in the inner radial end of the rigid seal plate and a second opening in the first clamp member; and a first force applicator operatively coupled to the first post and configured to force the first clamp member and the inner radial end of the rigid seal plate against the first mount member; and a second pivot coupler pivotally coupling the outer radial end of the rigid seal plate to the diffuser duct flange, the second pivot coupler including: a second mount member fixedly coupled to the diffuser duct flange and pivotally engaging the second axial side of the rigid seal plate, a second clamp member pivotally engaging the first axial side of the rigid seal plate, and at least one second actuator including: a second post fixedly coupled at one end thereof to the diffuser duct flange and extending through a third opening in the second mount member, the slot in the outer radial end of the rigid seal plate and a fourth opening in the second clamp member, and a second force applicator operatively coupled to the second post and configured to force the second clamp member and the outer radial end of the rigid seal plate against the second mount member.

Another aspect of the disclosure includes any of the preceding aspects, and further comprising: a first pair of post-interface seal plates at the outer radial end of the rigid seal plate, the first pair of post-interface seal plates including a first post-interface seal plate engaging the first axial side of the rigid seal plate between the rigid seal plate and the first mount member and a second post-interface seal plate engaging the second axial side of the rigid seal plate between the rigid seal plate and the first clamp member at the outer radial end of the rigid seal plate; a second pair of post-interface seal plates at the inner radial end of the rigid seal plate, the second pair of post-interface seal plates including a third post-interface seal plate engaging the first axial side of the rigid seal plate between the rigid seal plate and the second clamp member and a fourth post-interface seal plate engaging the second axial side of the rigid seal plate between the rigid seal plate and the second mount member; or both the first pair of post-interface seal plates and the second pair of post-interface seal plates.

Another aspect of the disclosure includes any of the preceding aspects, and the rigid seal plate includes opposing circumferential ends configured to mate with an adjacent rigid seal plate of an adjacent arcuate expansion joint segment, and further comprises at least one segment end interface seal plate extending across a gap extending from the outer radial end to the inner radial end at adjacent circumferential ends of arcuately adjacent rigid seal plates, the at least one segment end interface seal plate engaging one of the first axial side and the second axial side of the arcuately adjacent rigid seal plates and including at least one fifth opening through which a respective post extends, wherein the fifth opening is smaller than the through-hole or the slot adjacent thereto in the rigid seal plate.

Another aspect of the disclosure includes any of the preceding aspects, and the first and second mount members and the first and second clamp members are substantially hemispherical.

Another aspect of the disclosure includes any of the preceding aspects, and in a cold operating state of the gas turbine exhaust system, the inner radial end of the rigid seal plate is axially forward of the outer radial end of the rigid seal plate, and in a hot operating state of the gas turbine exhaust system the inner radial end of the rigid seal plate is axially rearward of the outer radial end of the rigid seal plate.

Two or more aspects described in this disclosure, including those described in this summary section, may be combined to form implementations not specifically described herein. That is, all embodiments described herein can be combined with each other.

The details of one or more implementations are set forth in the accompanying drawings and the description below. Other features, objects and advantages will be apparent from the description and drawings, and from the claims.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a schematic cross-sectional view of an expansion joint on a gas turbine exhaust system, according to embodiments of the disclosure;

FIG. 2 shows an enlarged cross-sectional view from view window A in FIG. 1 of an expansion joint in a cold operating state, according to embodiments of the disclosure;

FIG. 3 shows an enlarged cross-sectional view from view window A in FIG. 1 of an expansion joint in a hot operating state, according to embodiments of the disclosure;

FIG. 4 shows a schematic cross-sectional view along view line 4-4 in FIG. 1;

FIGS. 5A-B show axial views of a rigid seal plate of an expansion joint, according to various embodiments of the disclosure;

FIG. 6 shows an enlarged cross-sectional view of an expansion joint in another hot operating state, according to embodiments of the disclosure;

FIG. 7 shows an enlarged cross-sectional view of an expansion joint in yet another hot operating state, according to embodiments of the disclosure;

FIG. 8 shows a side view of mount members and clamp members of an expansion joint, according to embodiments of the disclosure;

FIG. 9 shows an enlarged cross-sectional view of an actuator of an expansion joint on an outer radial end of a rigid seal plate, according to embodiments of the disclosure;

FIG. 10 shows a schematic view of a force applicator including cone frustum springs, according to an alternative embodiment of the disclosure;

FIG. 11 shows an enlarged cross-sectional view from view window A in FIG. 1 of an expansion joint in a cold operating state and with post-interface seal plates, according to additional embodiments of the disclosure;

FIG. 12 shows an enlarged cross-sectional view from view window A in FIG. 1 of an expansion joint in a hot operating state and with post-interface seal plates, according to additional embodiments of the disclosure;

FIG. 13 shows an enlarged cross-sectional view of an expansion joint and, in particular, a rigid seal plate and post-interface seal plates, according to additional embodiments of the disclosure;

FIG. 14 shows a cross-sectional view along view line 14-14 in FIG. 13;

FIG. 15 shows a schematic axial view of an expansion joint where circumferential ends of adjacent rigid seal plates meet, according to embodiments of the disclosure;

FIG. 16 shows a top-down view of an expansion joint where circumferential ends of adjacent rigid seal plates meet, according to embodiments of the disclosure; and

FIG. 17 shows an enlarged cross-sectional view of an expansion joint, according to optional embodiments of the disclosure.

It is noted that the drawings of the disclosure are not necessarily to scale. The drawings are intended to depict only typical aspects of the disclosure and therefore should not be considered as limiting the scope of the disclosure. In the drawings, like numbering represents like elements between the drawings.

### DETAILED DESCRIPTION

As an initial matter, in order to clearly describe the subject matter of the current technology, it will become necessary to select certain terminology when referring to and describing relevant machine components within the illustrative application of a gas turbine system and, more particularly, an exhaust system thereof. When doing this, if possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part.

In addition, several descriptive terms may be used regularly herein, and it should prove helpful to define these terms at the onset of this section. These terms and their definitions, unless stated otherwise, are as follows. As used herein, “downstream” and “upstream” are terms that indicate a direction relative to the flow of a fluid, such as an exhaust flow through the gas turbine exhaust system. The term “downstream” corresponds to the direction of flow of the fluid, and the term “upstream” refers to the direction opposite to the flow. The terms “forward” and “aft,” without any further specificity, refer to directions, with “forward” referring to the front or compressor end of the turbomachine, and “aft” (or “rearward”) referring to the rearward or turbine end of the turbomachine.

It is often required to describe parts that are at different radial positions with regard to a center axis. The term “axial” refers to movement or position parallel to an axis, e.g., an axis of a GT exhaust system. The term “radial” refers to movement or position perpendicular to an axis, e.g., an axis of the GT exhaust system. In cases such as this, if a first component resides closer to the axis than a second component, it will be stated herein that the first component is “radially inward” or “inboard” of the second component. If, on the other hand, the first component resides further from the axis than the second component, it may be stated herein that the first component is “radially outward” or “outboard” of the second component. Finally, the term “circumferential” refers to movement or position around an axis, e.g., a circumferential interior surface of a diffuser duct flange extending about an axis of a GT exhaust system. As indicated above, it will be appreciated that such terms may be applied in relation to the axis of the GT exhaust system.

In addition, several descriptive terms may be used regularly herein, as described below. The terms “first,” “second,” and “third,” may be used interchangeably to distinguish one component from another and are not intended to signify location or importance of the individual components.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event may or may not occur or that the subsequently described feature may or may not be present and that the description includes instances where the event occurs or the feature is present and instances where the event does not occur or the feature is not present.

Where an element or layer is referred to as being “on,” “engaged to,” “connected to,” “coupled to,” or “mounted to” another element or layer, it may be directly on, engaged, connected, coupled, or mounted to the other element or layer, or intervening elements or layers may be present. In contrast, when an element is referred to as being “directly on,” “directly engaged to,” “directly connected to,” or “directly coupled to” another element or layer, there are no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. The verb forms of “couple” and “mount” may be used interchangeably herein.

Embodiments of the disclosure include an expansion joint for use in a gas turbine (GT) exhaust system. While the expansion joint has a wide variety of applications, the expansion joint will be described herein as between a turbine duct aft flange and a diffuser duct forward flange of a GT exhaust system. The expansion joint includes arcuate expansion joint segments configured to be arranged circumferentially to collectively form an annular expansion joint assembly. The expansion joint segments each include a rigid seal plate having an inner radial end and an outer radial end. A first pivot coupler pivotally couples the inner radial end of the rigid seal plate to the turbine duct flange, and a second pivot coupler pivotally couples the outer radial end of the rigid seal plate to the diffuser duct flange. The pivot couplers include a mount member fixedly coupled to a respective duct flange and pivotally engaging the rigid seal plate, a clamp member pivotally engaging the rigid seal plate on an opposing side thereof from the mount member, and actuator(s) configured to engage a respective radial end of the rigid seal plate between the clamp member and the mount member. The expansion joint is made from lower cost and more readily available material than current flexible seal elements. The expansion joint is also made of rigid material that can be exposed to higher exhaust temperatures and higher back pressures compared to current flexible expansion joints. The expansion joint is easy to assemble and does not require a separate trough for removing wash water.

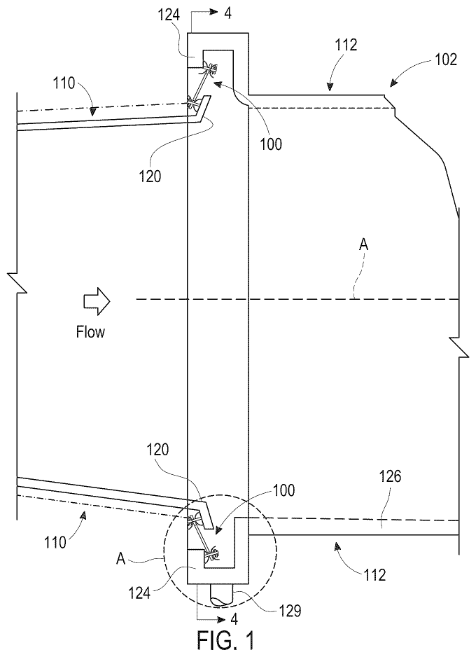

FIG. 1 shows a schematic cross-sectional view of an expansion joint 100 in an exemplary position on a gas turbine (GT) exhaust system 102, according to embodiments of the disclosure. As is shown, expansion joint 100 is positioned between a turbine duct 110 and a diffuser duct 112 of GT exhaust system 102. As noted, diffuser duct 112 provides performance benefits to the turbine (not shown, upstream thereof) as a whole by expanding the exhaust gases to achieve optimum aerodynamic pressure recovery. Turbine duct 110, being coupled to the upstream gas turbine, experiences high temperature combustion gases and, accordingly, includes high temperature machined or additively manufactured materials. In contrast, diffuser duct 112 experiences lower temperatures and is made of lower cost fabricated materials that are internally insulated. The thermal mismatch at this connection requires expansion joint 100 to accommodate the large relative displacements between these components, e.g., axially side-to-side on page and/or vertically (radially) up-down on page. For reference, GT exhaust system 102 is shown with an axis A.

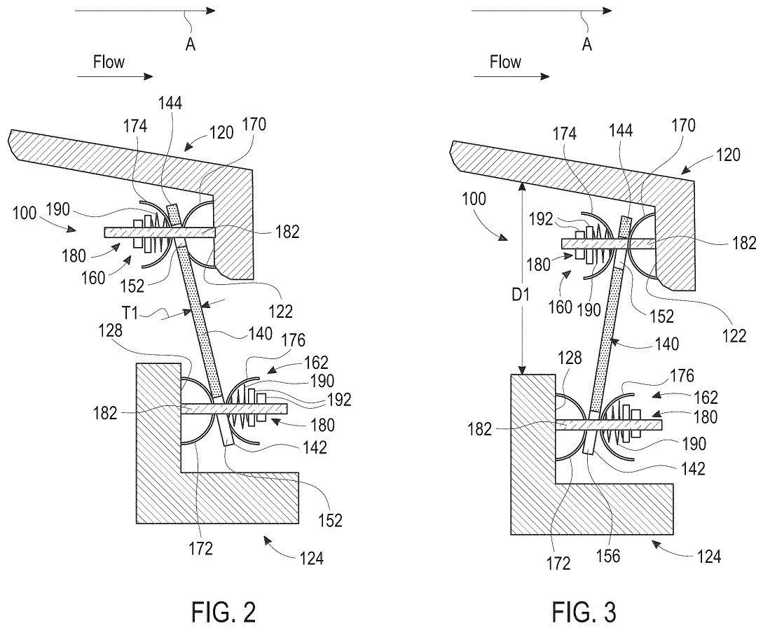

FIGS. 2 and 3 show enlarged cross-sectional views from view window A in FIG. 1 of expansion joint 100, according to embodiments of the disclosure. FIG. 2 shows expansion joint 100 in a cold operating state of GT exhaust system 102 (FIG. 1), and FIG. 3 shows expansion joint 100 in a hot operating state of GT exhaust system 102 (FIG. 1). Note, in FIGS. 2 and 3 and similar cross-sectional views herein, axis A of GT exhaust system 102 is vertically above the drawing on the page, but since the drawing is not to scale, axis A is illustrated closer than would be expected to expansion joint 100. In addition, it will be appreciated that ‘radially inward’ is up on the page, and ‘radially outward’ is down on the page of the cross-sectional views of expansion joint 100 herein, like FIGS. 2 and 3.

As shown, turbine duct 110 includes a turbine duct aft flange 120 for coupling to expansion joint 100. Turbine duct aft flange 120 (hereafter “turbine duct flange 120”) may include any now known or later developed flange element configured to couple to a gas turbine upstream thereof and expansion joint 100 radially outward thereof. In the example shown, turbine duct flange 120 includes an axially (forward) facing surface 122 of a conventional design. Diffuser duct 112 includes a diffuser duct forward flange 124 for coupling to expansion joint 100. Diffuser duct forward flange 124 (hereafter “diffuser duct flange 124”) may include any now known or later developed diffuser duct flange element configured to couple to a primary diffuser duct 126 (FIG. 1) downstream thereof and expansion joint 100 radially inward thereof. In the example shown, diffuser duct flange 124 includes an axially (rearward) facing surface 128 of a conventional design. Other types of duct flanges may be used herein, e.g., without axial facing surfaces 122, 128. FIG. 1 also shows an optional drainage opening 129 or similar type of structure positioned about the pair of flanges 120, 124 of expansion joint 100.

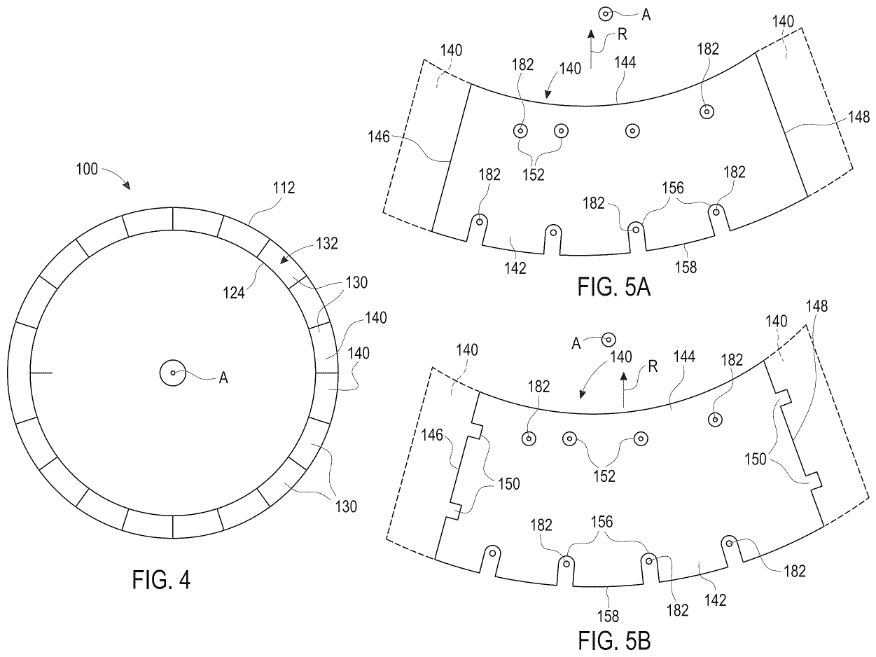

In exemplary embodiments illustrated herein, expansion joint 100 is used between turbine duct flange 120 and diffuser duct flange 124 of GT exhaust system 102 to accommodate the large relative displacements described herein. FIG. 4 shows a schematic cross-sectional view along view line 4-4 in FIG. 1, and through expansion joint 100. As shown in FIG. 4, expansion joint 100 includes a plurality of arcuate expansion joint segments 130 configured to be arranged circumferentially to collectively form an annular expansion joint assembly 132, i.e., forming an annular expansion joint 100. While expansion joint 100 is illustrated to couple turbine duct flange 120 and diffuser duct flange 124 of GT exhaust system 102, it should be appreciated that expansion joint 100 may alternately, or additionally, be used to couple forward and aft sections of the exhaust diffuser (the forward portion being shown in FIG. 1).

Referring to FIGS. 2-4, each arcuate expansion joint segment 130 includes a rigid seal plate 140 having an outer radial end 142 and an inner radial end 144. FIGS. 5A-B show axial views of rigid seal plate 140 according to embodiments of the disclosure. Note, FIGS. 5A-B, like FIGS. 2 and 3, are arranged so axis A of GT exhaust system 102 would be vertically above the drawings on the page; hence, outer radial end 142 of rigid seal plate 140 is on the bottom of FIGS. 5A-B. FIGS. 5A-B do not show other parts of expansion joint 100 such as mount members, clamp members or optional post-interface seal plates, as will be described further herein.

Rigid seal plate 140 may be made of any material capable of withstanding the temperatures of the exhaust passing therethrough. In one embodiment, rigid seal plate 140 is made of a stainless steel, such as but not limited to a 304 or 347 grade stainless steel. Rigid seal plate 140 has a thickness T1 (FIG. 2) configured to be stiff and not able to be bent or flexed during operation. In certain embodiments, rigid seal plate 140 may have a thickness T1 in a range of 5 to 10 millimeters (mm). In other embodiments, rigid seal plate 140 may have a thickness T1 in a range of 6 to 9 mm. In other embodiments, rigid seal plate 140 may have a thickness T1 in a range of 7 to 8 mm. Rigid seal plate 140 may have any length, i.e., from inner radial end 144 to outer radial end 142, necessary to span a distance between mount/clamp member pairs 170, 174 and 172, 176 regardless of thermal condition of GT exhaust system 102 (FIG. 1).

As shown in FIGS. 5A-B, rigid seal plate 140 may be arcuate and may include opposing circumferential ends 146, 148 configured to mate with an adjacent rigid seal plate 140 of an adjacent arcuate expansion joint segment 130 (FIG. 4). The angular extent of rigid seal plates 140 can be user-defined, e.g., they can extend 10°, 15°, 20°, 30°, 40°, 45°, etc., depending on how many arcuate segments 130 (FIG. 4) are desired. In the FIG. 5A embodiment, circumferential ends 146, 148 extend in a direction relative to radial direction R so as to abut adjacent rigid seal plates (dashed boxes on either side of the seal plate shown). Circumferential ends 146, 148 may be aligned with radial direction R or correspondingly angled relative to radial direction R. In the FIG. 5B embodiment, rigid seal plate 140 optionally includes a male-female coupler 150 on circumferential ends 146, 148 thereof configured to mate with a circumferentially adjacent rigid seal plate (dashed boxes on either side of the seal plate shown) to prevent leaks. Male-female couplers 150 can take any form configured to position circumferentially adjacent rigid seal plates 140 in a desired position, e.g., circumferentially and axially aligned, and to reduce leakage. While shown as mating polygonal shapes, the male-female couplers 150 can have different forms than that shown, e.g., rounded concave/convex, triangular, etc.

Rigid seal plate 140 also includes openings therein for mounting it to turbine duct flange 120 and diffuser duct flange 124. More particularly, as shown in FIGS. 5A-B, rigid seal plate 140 includes an opening 152 in inner radial end 144 of rigid seal plate 140 that includes a through-hole extending through rigid seal plate 140, i.e., axially through rigid seal plate into and out of the page. Further, rigid seal plate 140 includes an opening 156 in outer radial end 142 of rigid seal plate 140 that includes a slot extending through rigid seal plate 140, i.e., axially into/out of page, and open to a radial outer edge 158 of rigid seal plate 140. As will be further described, the number of each opening 152, 156 may match the number of pivot couplers 160, 162 (see, e.g., FIGS. 2 and 3) used to pivotally couple the respective radial end 142, 144 of rigid seal plate 140 to duct flanges 120, 124. Hereafter, when openings 152, 156 are referenced separately, opening 152 may be referenced as “through-hole 152” and opening 156 may be referenced as “slot 156” for clarity of differentiation.

As shown in FIGS. 2-3, expansion joint 100 also includes a first pivot coupler 160 pivotally coupling inner radial end 144 of rigid seal plate 140 to turbine duct flange 120, and a second pivot coupler 162 pivotally coupling outer radial end 142 of rigid seal plate 140 to diffuser duct flange 124. Respectively, pivot couplers 160, 162 include a mount member 170, 172 fixedly coupled to a respective duct flange 120, 124 and pivotally engaging rigid seal plate 140. In addition, pivot couplers 160, 162 include a clamp member 174, 176, respectively, pivotally engaging rigid seal plate 140. Each mount member 170, 172 and clamp member 174, 176 engages an axial side of rigid seal plate 140, i.e., a side facing generally axially but for the tilting of rigid seal plate 140 in GT exhaust system 102 (FIG. 1). As will be described, at least one actuator 180 is configured to press a respective radial end 142, 144 of rigid seal plate 140 between a clamp member 174, 176 and a respective mount member 170, 172.

Mount member 170, 172 and clamp member 174, 176 are curved to pivotally engage rigid seal plate 140 and to allow it to rotate relative to the members and maintain engagement therewith to create a seal regardless of the position of duct flanges 120, 124 relative to one another. For example, as noted, FIG. 2 shows expansion joint 100 in a cold operating state of GT exhaust system 102 (FIG. 1) in which turbine duct flange 120 is contracted in a forward axial direction (to left on page) relative to diffuser duct flange 124. In the cold operating state of GT exhaust system 102 (FIG. 1), inner radial end 144 of rigid seal plate 140 is axially forward of outer radial end 142 of rigid seal plate 140. In contrast, FIG. 3 shows expansion joint 100 in a hot operating state of GT exhaust system 102 (FIG. 1) in which turbine duct flange 120 is extended in a rearward axial direction (to right on page) relative to diffuser duct flange 124. In the hot operating state of GT exhaust system 102 (FIG. 1), inner radial end 144 of rigid seal plate 140 is axially rearward of outer radial end 142 of rigid seal plate 140. Despite the different axial positions, rigid seal plate 140 remains in contact with members 170, 172, 174, 176 to seal between duct flanges 120, 124.

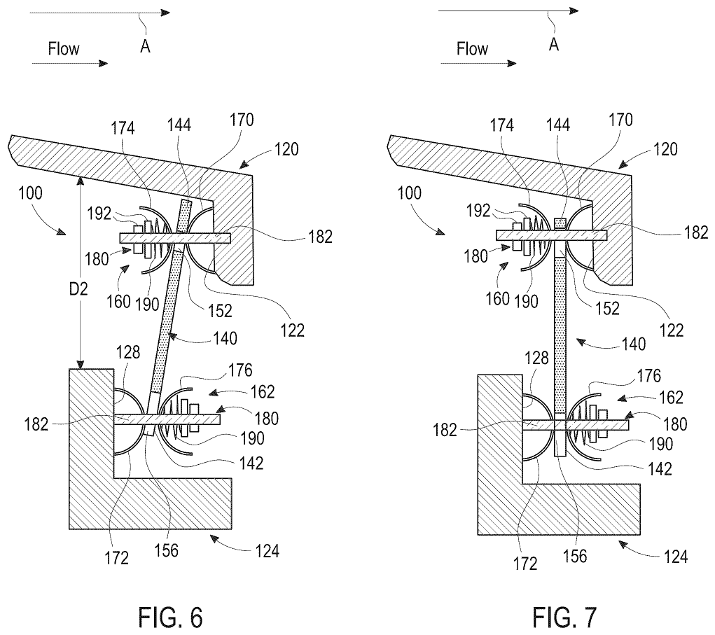

FIG. 6 shows an enlarged cross-sectional view of expansion joint 100 in another hot operating state of GT exhaust system 102 (FIG. 1), and FIG. 7 shows an enlarged cross-sectional view of expansion joint 100 in yet another hot operating state of GT exhaust system 102 (FIG. 1). As shown in FIG. 6, as will be further described herein, expansion joint 100 also accommodates radial expansion (vertical on page) of flanges 120, 124. For example, the position of expansion joint 100 in FIG. 6 is similar to FIG. 3 except radial distance D1 (FIG. 3) between flanges 120, 124 has enlarged to radial distance D2 due to radial thermal expansion in the hot operating state depicted in FIG. 6. Despite the radial expansion, rigid seal plate 140 remains engaged by mount members 170, 172 and clamp members 174, 176. FIG. 7 shows expansion joint 100 in another position during hot operating state of GT exhaust system 102 where rigid seal plate 140 is vertically oriented. In such an orientation, inner radial end 144 is axially aligned with outer radial end 142.

Mount members 170, 172 and clamp members 174, 176 may be cross-sectionally curved in any desired manner to ensure engagement with rigid seal plate 140 during operation. In certain embodiments, one or more of mount members 170, 172 and clamp members 174, 176 may be cross-sectionally substantially hemispherical. As used herein, “substantially hemispherical” means 180°, +/−5°. In this example, mount members 170, 172 and clamp members 174, 176 may be made from cylindrical pipe halves fixed to a respective duct flange 120, 124. The cylindrical pipe diameter used can be based on a wide variety of factors such as but not limited to the size of flanges 120, 124 and/or GT exhaust system 102 and/or expected thermal expansion/contraction. Although the curve of mount members 170, 172 and clamp member 174, 176 are shown as identical in a given pivotal coupler and amongst pivotal couplers, that is not necessary, i.e., the curvature need not be identical amongst the members. Mount members 170, 172 may be fixedly coupled to a respective duct flange 120, 124, e.g., to axially facing surfaces 122, 128 thereof, by any means such as but not limited to welding, brazing, fasteners, or integral formation therewith using casting or additive manufacture.

Mount members 170, 172 and clamp members 174, 176 are also rigid, like rigid seal plate 140, and may be made of the same material as rigid seal plate 140. In certain embodiments, rigid seal plate 140, clamp member(s) 174, 176 and mount member(s) 170, 172 are made from and/or include a stainless steel. In other embodiments, different materials for mount members 170, 172 and/or clamp members 174, 176 compared to rigid seal plate 140 are also possible, e.g., different types of steel or steel alloys.

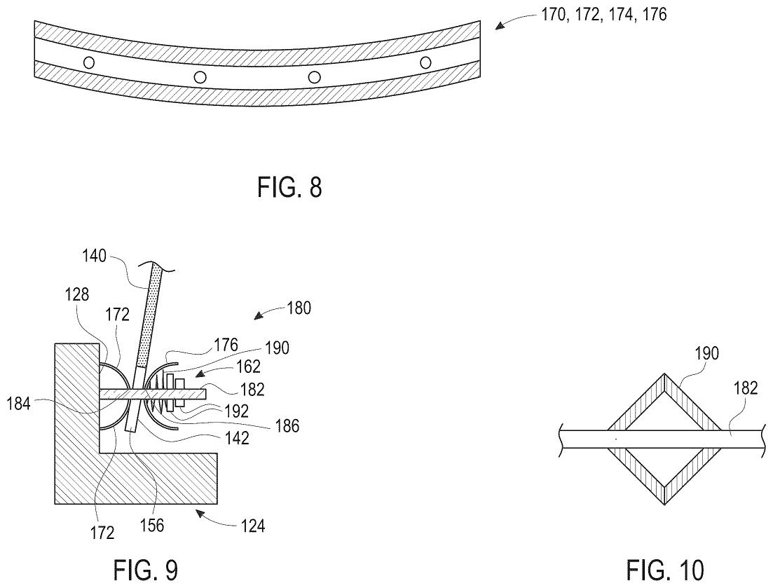

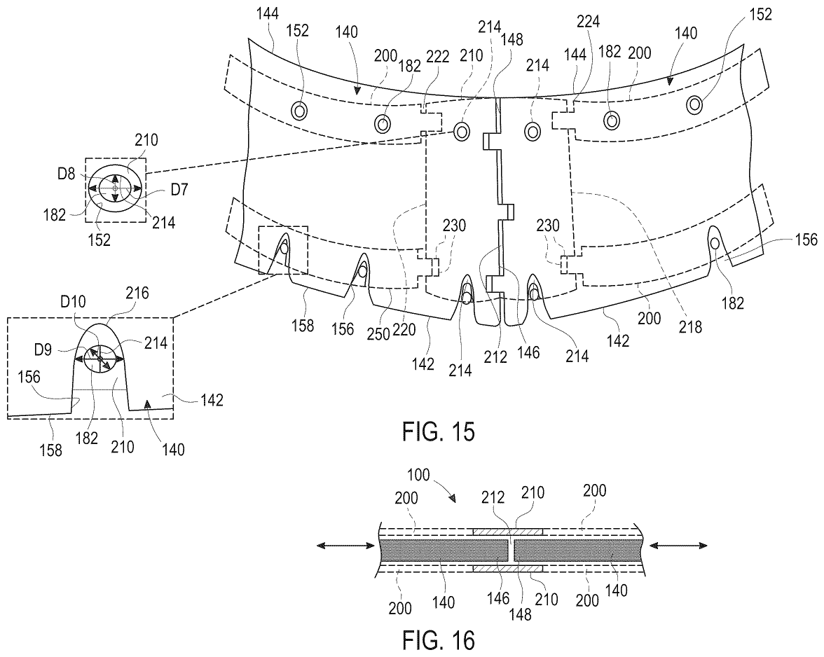

FIG. 8 shows a side view of mount members 170, 172 and clamp members 174, 176 according to embodiments of the disclosure. In addition to the cross-sectional curvature, as shown in FIGS. 2, 3, 6 and 7, mount members 170, 172 and clamp members 174, 176 may also be curved longitudinally to match or nearly match the arcuate curvature of rigid seal plate 140, as shown in FIGS. 5A-B. In certain embodiments, mount members 170, 172 and clamp members 174, 176 may extend the same arcuate extent as rigid seal plate 140. In other embodiments, as will be described herein, mount members 170, 172 and clamp members 174, 176 may be arcuately shorter than rigid seal plate 140 to accommodate a segment end interface seal plate 210 (FIGS. 15-16) extending across a gap extending from outer radial end 142 to inner radial end 144 adjacent circumferential ends 146, 148 (FIGS. 5A-B) of arcuately adjacent rigid seal plates 140.

Actuator(s) 180 may take any form capable of forcing clamp members 174, 176 to press rigid seal plate 140 against a respective mount member 170, 172. Depending on the arcuate extent of rigid seal plates 140 used, e.g., 10°, 15°, 30°, etc., and the space available, any number of actuators 180 can be used on each rigid seal plate 140. That is, while a single actuator 180 is shown at each of outer radial end 142 and inner radial end 144 in, for example, FIGS. 2 and 3, any number of actuators 180 can be used in each rigid seal plate 140—arranged into and/or out of page along an arcuate extent of rigid seal plate 140. In certain embodiments, an actuator 180 is present for each set of openings 152, 156, as shown in FIGS. 5A-B, and openings 152, 156 are present to accommodate actuator(s) 180.

Actuator(s) 180 will now be described with reference to an illustrative actuator 180 on outer radial end 142 of rigid seal plate 140 in FIGS. 2 and 3. For additional clarity, FIG. 9 shows an enlarged cross-sectional view of actuator 180 on outer radial end 142 of rigid seal plate 140. As shown in FIGS. 2, 3 and 9, in certain embodiments, actuator(s) 180 include a post 182 fixedly coupled at one end thereof to a respective duct flange 120, 124 (duct flange 124 as shown) and extending through an opening 184 in mount member 170, 172 (mount member 172 as shown). Opening 184 can be a through-hole through mount member 170, 172. Post 182 also extends through an opening in a respective radial end of rigid seal plate 140. At outer radial end 142, as shown in FIGS. 2, 3, 5A-B and 9, the opening is slot 156, and at radial inner end 144, as shown in FIGS. 2, 3 and 5A-B, the opening is through-hole 152. Post 182 also extends through an opening 186 in clamp member 174, 176 (clamp member 176 as shown). Opening 186 can be a through-hole through clamp member 176. Through-hole 152 and slot 156 in rigid seal plate 140, openings 184 in mount members 170, 172, openings 186 in clamp members 174, 176 and posts 182 are all sized to accommodate movement of rigid seal plate 140, e.g., based on thermal expansion or contraction of any part of expansion joint 100, turbine duct flange 120 or diffuser duct flange 124.

Actuator(s) 180 also include a force applicator 190 operatively coupled to post 182. In certain embodiments, force applicator 190 may include a compression spring or any form of spring capable of applying an expansion force along post 182. In certain embodiments, as shown in FIGS. 2, 3 and 9, the compression spring includes one or more coil springs, and, in other embodiments, as shown in FIG. 10, the compression spring includes one or more cone frustum springs (also known as a Belleville spring). Other types of force applicators and/or springs are also possible. Although the compression spring(s) are shown surrounding post 182, this is not necessary in all cases and other types of springs may oriented differently.

Actuator(s) 180 also include a holder 192 that is coupled to post 182 and that engages force applicator 190. Holder 192 may include any form of structural element capable of selective fixation on post 182 to provide a foundation for force applicator 190, e.g., a compression spring. In the example shown, post 182 may be outwardly threaded along at least a portion thereof, and holder 192 may be threadedly adjustably coupled to the at least portion of post 182. In this example, holder 192 may include a washer and bolt combination, or just a bolt. It will be recognized that other forms of holders 192 are also possible for threaded or unthreaded posts 182, such as but not limited to clamps, pins such as cotter pins, and fixed structure such as welded-on washers or collars.

In operation, in one non-limiting example, duct flanges 120, 124 may axially contract/expand up to 20 centimeters (˜7.8 inches) and radially contract/expand up to 5 centimeters (˜2 inches). Actuator(s) 180, regardless of form of force applicator 190, force clamp member 174, 176 and respective radial end 142, 144 of rigid seal plate 140 against the respective mount member 170, 172. In this manner, actuator(s) 180 ensure a sealing relationship between rigid seal plate 140 and each duct flange 120, 124 regardless of the degree of thermal expansion/contraction of duct flanges 120, 124. Axial thermal expansion/contraction, as illustrated by the different positions in FIGS. 2, 3 and 7, is accommodated by the pivotal engagement between rigid seal plate 140, mount members 170, 172, clamp members 174, 176 and actuator(s) 180. As shown in FIGS. 2, 3 and 6, the size of through-hole 152 relative to post 182 and the size and shape of slot 156 relative to post 182 allow radial thermal expansion/contraction as duct flanges 120, 124 expand/contract radially, i.e., vertically on page. In particular, slot 156 provides radial expansion/contraction of duct flanges 120, 124 while maintaining a sealing relationship with rigid seal plate 140.

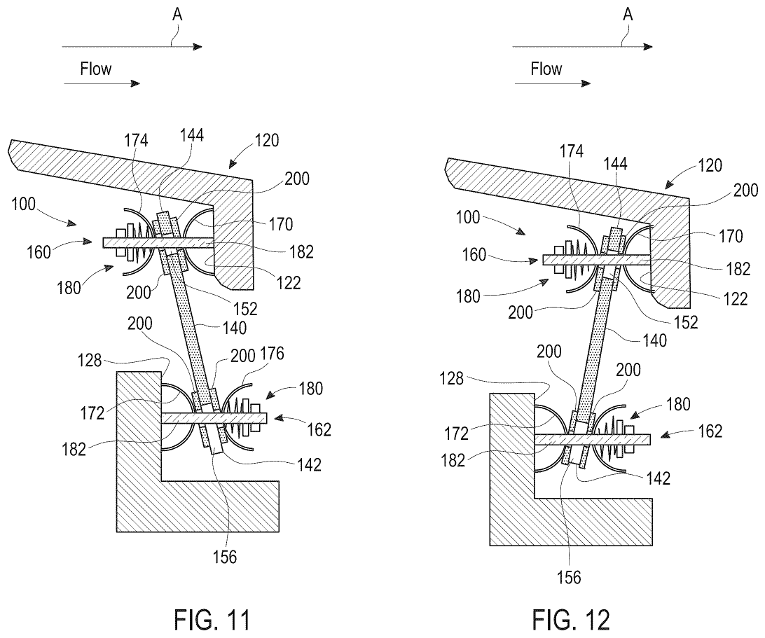

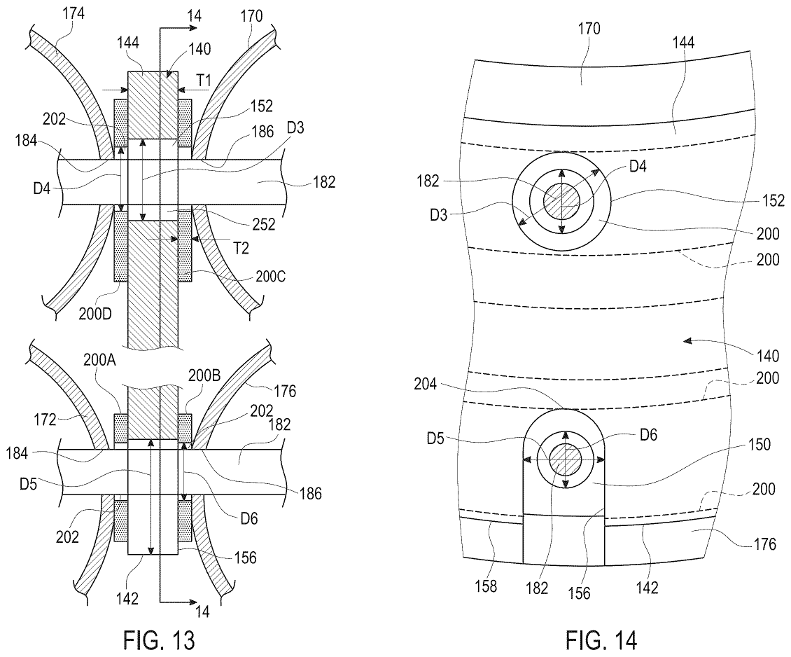

In certain situations, an area around posts 182 in through-holes 152 and/or slots 156 may allow too much gas flow therethrough. FIGS. 11 and 12 show enlarged cross-sectional views from view window A in FIG. 1 of expansion joint 100, according to additional embodiments of the disclosure. Similar to FIGS. 2 and 3, FIG. 11 shows expansion joint 100 in a cold operating state of GT exhaust system 102 (FIG. 1) and FIG. 12 shows expansion joint 100 in a hot operating state of GT exhaust system 102 (FIG. 1). FIG. 13 shows an enlarged cross-sectional view of expansion joint 100 and, in particular, rigid seal plate 140, according the additional embodiments shown in FIGS. 11-12. FIG. 14 shows a cross-sectional view along view line 14-14 in FIG. 13. In FIGS. 11-14, expansion joint 100 may also include at least one post-interface seal plate 200 (200A-D in FIGS. for later differentiation) engaging an axial side of rigid seal plate 140 between rigid seal plate 140 and one of mount member 170, 172 and clamp member 174, 176 adjacent openings 152, 156 (through-hole 152 or slot 156) at a respective radial end 144, 142 of rigid seal plate 140. Each post-interface seal plate 200 is longitudinally arcuate and includes at least one opening 202 through which a respective post 182 extends. Notably, as shown in FIGS. 13-14, opening(s) 202 in post-interface seal plate 200 are smaller than openings 152, 156 adjacent thereto in rigid seal plate 140 so as to further restrict gas leakage through rigid seal plate 140 and expansion joint 100. That is, diameter D3 of through-hole 152 in inner radial end 144 of rigid seal plate 140 is larger than diameter D4 of opening 202 in post-interface seal plate 200 adjacent thereto. Similarly, as shown in FIGS. 13-14, a maximum circumferential dimension D5 of slot 156 in outer radial end 142 of rigid seal plate 140 is larger than diameter D6 of opening 202 in post-interface seal plate 200 adjacent thereto. Diameter D6 of opening 202 in post-interface seal plate 200 adjacent slot 156 is also smaller than a longitudinal extent of slot 156 from an inner end 204 thereof to radial outer edge 158 of rigid seal plate 140. In some embodiments, diameter D6 of opening 202 adjacent slot 156 may be the same as diameter D4 of opening 202 adjacent through-hole 152, while in other embodiments, diameter D6 and diameter D4 may be different. Post-interface seal plates 200 may include an opening 202 for each actuator 180 for which it interacts.

Post-interface seal plates 200 may have any radial extent desired, but are typically short enough to not extend beyond outer radial end 142 or inner radial end 144 of rigid seal plate 140. Post-interface seal plates 200 are thinner than rigid seal plate 140, and in one non-limiting example, may have a thickness T2 (FIG. 13) in a range of 2-4 millimeters. Post-interface seal plates 200 are longitudinally arcuate, like rigid seal plate 140, and may extend the same arcuate extent as rigid seal plate 140 or a portion thereof (FIG. 15). Post-interface seal plates 200 may also extend across mating circumferential ends 146, 148 (FIGS. 5A-B) of adjacent rigid seal plates 140, so as to be shared by adjacent rigid seal plates 140. The arcuate extents of post-interface seal plates 200 may be the same or different than mount members 170, 172 and/or clamp members 174, 176. In any event, post-interface seal plates 200 slidingly and pivotally move along with rigid seal plate 140 as it slides and/or pivots relative to mount members 170, 172 and clamp members 174, 176.

In the examples shown in FIG. 13, a post-interface seal plate 200 is provided between rigid seal plate 140 and each mount member 170, 172 and clamp member 174, 176. That is, expansion joint 100 includes a first post-interface seal plate 200A engaging a first axial side (forward side as shown) of rigid seal plate 140 between rigid seal plate 140 and mount member 172 at outer radial end 142 of rigid seal plate 140; a second post-interface seal plate 200B engaging a second axial side (rearward side) of rigid seal plate 140 between rigid seal plate 140 and clamp member 176 at outer radial end 142 of rigid seal plate 140; a third post-interface seal plate 200C engaging the second axial side (rearward side) of rigid seal plate 140 between rigid seal plate 140 and mount member 170 at inner radial end 144 of the rigid seal plate 140; and a fourth post-interface seal plate 200D engaging the first axial side (forward side) of rigid seal plate 140 between rigid seal plate 140 and clamp member 174 at inner radial end 144 of rigid seal plate 140. While post-interface seal plates 200A-D are shown between rigid seal plate 140 and each mount member 170, 172 and clamp member 174, 176, they do not need to be used at each location, i.e., they can be omitted where desired. For example, in some cases, only post-interface seal plates 200A, 200B may be used where slots 156 are present due to their larger area compared to post 182.

In operation, actuator(s) 180, regardless of form of force applicator 190, forces clamp member 174, 176 and respective radial end 144, 142 of rigid seal plate 140 with post-interface seal plates 200 against the respective mount member 170, 172. In this manner, actuator(s) 180 ensure a sealing relationship among rigid seal plate 140, post-interface seal plates 200, and each duct flange 120, 124 regardless of the thermal expansion/contraction of duct flanges 120, 124. Post-interface seal plates 200 are held radially by posts 182. Axial thermal expansion/contraction, as illustrated by the different positions in FIGS. 11 and 12, is accommodated by the pivotal engagement between rigid seal plate 140, mount members 170, 172, clamp members 174, 176 and actuator(s) 180. As shown in FIGS. 11 and 12, the size of through-hole 152 relative to post 182 and the size and shape of slot 156 relative to post 182 allow radial thermal expansion/contraction as duct flanges 120, 124 expand/contract radially, i.e., vertically on page. As noted, slot 156 provides radial expansion/contraction of duct flanges 120, 124 while maintaining a sealing relationship with rigid seal plate 140. Simultaneously, post-interface seal plates 200 improve the sealing relationship and reduce leakage through through-hole opening 152 and slot 156.

As described relative to FIGS. 5A-B, rigid seal plate 140 includes opposing circumferential ends 146, 148 configured to mate with a circumferentially adjacent rigid seal plate 140 of an circumferentially adjacent arcuate expansion joint segment 130 (FIG. 4). FIG. 15 shows a schematic axial view, and FIG. 16 shows a top-down view of expansion joint 100 where circumferential ends 146, 148 of adjacent rigid seal plates 140 meet. In certain embodiments, expansion joint 100 may further include at least one segment end interface seal plate 210 extending across a gap 212 extending from outer radial end 142 to inner radial end 144 at adjacent circumferential ends 146, 148 of arcuately adjacent rigid seal plates 140. In FIG. 15, only one segment end interface seal plate 210 is used, and in FIG. 16, a segment end interface seal plate 210 extends across gap 212 on both sides of circumferentially adjacent rigid seal plates 140. Each segment end interface seal plate 210 engages an axial side of arcuately adjacent rigid seal plates 140. Each segment end interface seal plate 210 may also include at least one opening 214, shown in FIG. 15 only for clarity, through which a respective post 182 extends. However, not all segment end interface seal plates 210 may intersect with a post 182 of actuators 180. Similar to post-interface seal plates 200, where provided, opening 214 is smaller than opening 152, 156 (through-hole 152 or slot 156) adjacent thereto in rigid seal plate 140. That is, diameter D7 of through-holes 152 in inner radial ends 144 of circumferentially adjacent rigid seal plates 140 are larger than diameter D8 of opening 214 in segment end interface seal plate(s) 210 adjacent thereto. Similarly, as shown in FIG. 15, a diameter D9 of slot 156 in outer radial ends 142 of circumferentially adjacent rigid seal plates 140 is defined in the circumferential direction and measured along a transverse plane that includes a center of post 182. Diameter D9 is larger than diameter D10 of opening 214 in segment end interface seal plate 210 adjacent thereto. Diameter D10 of opening 214 in segment end interface seal plate 210 adjacent slot 156 is also smaller than a longitudinal extent of slot 156 from an inner end 216 thereof to radial outer edge 158 of rigid seal plate 140. Segment end interface seal plates 210 may include an opening 214 for each actuator 180 for which it interacts, if any.

As shown in FIG. 15, circumferential ends 218, 220 of segment end interface seal plate(s) 210 and circumferentially ends 222, 224 of post-interface seal plate(s) 200 may include mating male-female couplers 230 to prevent leaks. Male-female couplers 230 can take any form configured to position circumferentially adjacent segment end interface seal plate(s) 210 and post-interface seal plate(s) 200 in a desired position, e.g., circumferentially and axially aligned, and to reduce leakage. While shown as mating polygonal shapes, the male-female couplers 230 can have different forms than that shown, e.g., rounded concave/convex, triangular, etc. Any number of male-female couplers 230 may be used. In operation, segment end interface seal plate(s) 210 and circumferentially ends 222, 224 of post-interface seal plate(s) 200 cooperate to improve the sealing relationship and reduce leakage through gap 212 and any through-hole opening 152 and slot 156 therein.

Post-interface seal plates 200 and segment end interface seal plate(s) 210 may be made of any of the materials listed herein for mount members 170, 174, clamp members 172, 176 and rigid seal plate 140.

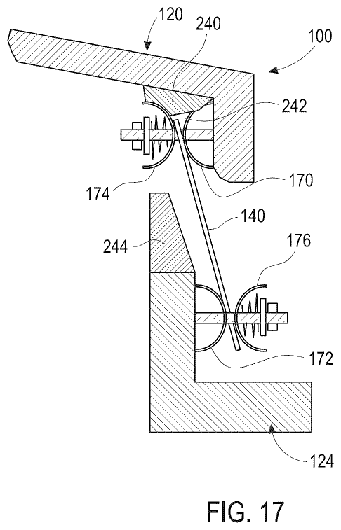

FIG. 17 shows an enlarged cross-sectional view of expansion joint 100, according to optional embodiments of the disclosure. In these optional embodiments, expansion joint 100 may further include a wire mesh seal member 240 filling a gap 242 between an adjacent duct flange 120, 124, clamp member 174 and mount member 170. Other wire mesh seal members 244 may be used elsewhere in expansion joint 100 as needed.

As shown, for example, in FIGS. 2, 3 and 9, embodiments of the disclosure may also include expansion joint 100 for use between turbine duct flange 120 and diffuser duct flange 124 of GT exhaust system 102 (FIG. 1). Expansion joint 100 may include, as shown in FIG. 4, a plurality of arcuate expansion joint segments 130 configured to be arranged collectively to form an annular expansion joint assembly 132. Each arcuate expansion joint segment 130 includes rigid seal plate 140 having inner radial end 144, outer radial end 142, through-hole 152 extending through inner radial end 144 of rigid seal plate 140, and slot 156 extending through outer radial end 142 of rigid seal plate 140 and open to radial outer edge 158 of rigid seal plate 140.

Expansion joint 100 may also include a first pivot coupler 160 pivotally coupling inner radial end 144 of rigid seal plate 140 to turbine duct flange 120. First pivot coupler 160 includes first mount member 170 fixedly coupled to turbine duct flange 120 and pivotally engaging a first axial side (rearward side) of rigid seal plate 140. First pivot coupler 160 also includes a first clamp member 174 pivotally engaging second axial side (forward side) of rigid seal plate 140 opposite the first axial side of rigid seal plate 140. First pivot coupler 160 also includes at least one first actuator 180. Each first actuator 180 includes a first post 182 fixedly coupled at one end thereof to turbine duct flange 120 and extending through opening 184 in first mount member 170, through-hole 152 in inner radial end 144 of rigid seal plate 140 and opening 186 in first clamp member 174. First actuators 180 also include a first force applicator 190, e.g., compression spring, operatively coupled to first post 182 and configured to force first clamp member 174 and inner radial end 144 of rigid seal plate 140 against first mount member 170. Holder 192, which is coupled to post 182, engages force applicator 190 and maintains the force exerted by force applicator 190 on first clamp member 174. Optionally, as shown in FIGS. 11-13, expansion joint 100 may include one or more post-interface seal plates 200 (e.g., one on either side of rigid seal plate 140) to reduce air flow through through-hole 152.

Expansion joint 100 also includes a second pivot coupler 162 pivotally coupling outer radial end 142 of rigid seal plate 140 to diffuser duct flange 124. Second pivot coupler 162 includes a second mount member 172 fixedly coupled to diffuser duct flange 124 and pivotally engaging the second axial side (forward side) of rigid seal plate 140. Second pivot coupler 162 also includes a second clamp member 176 pivotally engaging the first axial side (rearward side) of rigid seal plate 140, and at least one second actuator 180. Second actuator(s) 180 include a second post 182 fixedly coupled at one end thereof to diffuser duct flange 124 and extending through opening 184 in second mount member 172, slot 156 in outer radial end 142 of rigid seal plate 140, and opening 186 in second clamp member 176. Second actuator(s) 180 also include a second force applicator 190, e.g., a compression spring, operatively coupled to second post 182 and configured to force second clamp member 176 and outer radial end 142 of rigid seal plate 140 against second mount member 172. Holder 192, which is coupled to post 182, engages force applicator 190 and maintains the force exerted by force applicator 190 on second clamp member 176. Optionally, as shown in FIGS. 11-13, expansion joint 100 may include one or more post-interface seal plates 200 (e.g., one on either side of rigid seal plate 140) to reduce air flow through slot 156.

Embodiments of the disclosure provide various technical and commercial advantages, examples of which are discussed herein. The expansion joint is made from lower cost and more readily available material than current flexible seal elements. For example, the mount and clamp members can be made from longitudinally cut and bent cylindrical pipes; the actuators can be made from standard threaded bolts, springs, fasteners; and the rigid steel plate can be formed from standard stainless-steel plate. The rigid seal plate provides a stronger seal element with no bending stresses compared to conventional flexible seal elements. The rigid seal plate also allows the expansion joint to be exposed to higher exhaust temperatures compared to current flexible expansion joints, such as higher temperatures experienced combusting hydrogen fuel, e.g., higher than 650° C. (˜1200°F). The rigid seal plate, among other parts of the expansion joint, also resists higher back pressures that may exist due to more complex emissions control systems downstream in the GT exhaust system. The expansion joint, however, is easy to assemble, and does not require a separate trough for removing wash water. The expansion joint may also facilitate the movement of water wash drain liquid to drainage opening 129 (FIG. 1).

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise. “Approximately” or “about,” as applied to a particular value of a range, applies to both end values and, unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiments were chosen and described in order to best explain the principles of the disclosure and the practical application of the technology and to enable others of ordinary skill in the art to understand the disclosure for contemplating various modifications to the present embodiments, which may be suited to the particular use contemplated.

What is claimed is:

1. An expansion joint for use between a turbine duct flange and a diffuser duct flange of a gas turbine exhaust system, the expansion joint comprising:
a plurality of arcuate expansion joint segments configured to be arranged circumferentially to collectively form an annular expansion joint assembly, the plurality of arcuate expansion joint segments each including:
a rigid seal plate having an inner radial end and an outer radial end;
a first pivot coupler pivotally coupling the inner radial end to the turbine duct flange; and
a second pivot coupler pivotally coupling the outer radial end to the diffuser duct flange,
wherein each of the first and second pivot couplers includes:
a mount member fixedly coupled to a respective duct flange and pivotally engaging the rigid seal plate;
a clamp member pivotally engaging the rigid seal plate; and
at least one actuator configured to press a respective radial end of the rigid seal plate between the clamp member and the mount member.

2. The expansion joint of claim 1, wherein the at least one actuator includes:
a post fixedly coupled at one end thereof to a respective duct flange and extending through a first opening in the mount member, a second opening in a respective radial end of the rigid seal plate, and a third opening in the clamp member;
a force applicator operatively coupled to the post; and
a holder coupled to the post and engaging the force applicator,
wherein the force applicator forces the clamp member and the respective radial end of the rigid seal plate against the mount member.

3. The expansion joint of claim 2, wherein the second opening in the inner radial end of the rigid seal plate includes a through-hole extending through the rigid seal plate, and the second opening in the outer radial end of the rigid seal plate includes a slot extending through the rigid seal plate and open to a radial outer edge of the rigid seal plate.

4. The expansion joint of claim 2, further comprising at least one post-interface seal plate engaging an axial side of the rigid seal plate between the rigid seal plate and one of the mount member and the clamp member adjacent the second opening at a respective radial end of the rigid seal plate, the at least one post-interface seal plate including at least one third opening through which a respective post extends, wherein the at least one third opening is smaller than the second opening adjacent thereto in the rigid seal plate.

5. The expansion joint of claim 4, wherein the at least one post-interface seal plate includes:
a first pair of post-interface seal plates at the outer radial end of the rigid seal plate, the first pair of post-interface seal plates including a first post-interface seal plate engaging a first axial side of the rigid seal plate between the rigid seal plate and the mount member and a second post-interface seal plate engaging a second axial side of the rigid seal plate between the rigid seal plate and the clamp member;
a second pair of post-interface seal plates at the inner radial end of the rigid seal plate, the second pair of post-interface seal plates including a third post-interface seal plate engaging the second axial side of the rigid seal plate between the rigid seal plate and the mount member and a fourth post-interface seal plate engaging the first axial side of the rigid seal plate between the rigid seal plate and the clamp member; or
both the first pair of post-interface seal plates and the second pair of post-interface seal plates.

6. The expansion joint of claim 4, wherein the rigid seal plate includes opposing circumferential ends configured to mate with an adjacent rigid seal plate of an adjacent arcuate expansion joint segment, and further comprises at least one segment end interface seal plate extending across a gap extending from the outer radial end to the inner radial end at adjacent circumferential ends of arcuately adjacent rigid seal plates, each segment end interface seal plate engaging an axial side of the arcuately adjacent rigid seal plates and including at least one third opening through which a respective post extends, wherein the third opening is smaller than the second opening adjacent thereto in the rigid seal plate.

7. The expansion joint of claim 6, wherein circumferential ends of the at least one segment end interface seal plate and circumferential ends of the at least one post-interface seal plate include mating male-female couplers.

8. The expansion joint of claim 2, wherein the force applicator includes a compression spring selected from a group comprising a coil spring and a cone frustum spring.

9. The expansion joint of claim 2, wherein the post is outwardly threaded along at least a portion thereof, and the holder is threadedly adjustably coupled to the at least portion of the post.

10. The expansion joint of claim 1, wherein in a cold operating state of the gas turbine exhaust system, the inner radial end of the rigid seal plate is axially forward of the outer radial end of the rigid seal plate, and in a hot operating state of the gas turbine exhaust system the inner radial end of the rigid seal plate is axially rearward of the outer radial end of the rigid seal plate.

11. The expansion joint of claim 1, wherein the mount member and the clamp member are both substantially hemispherical.

12. The expansion joint of claim 11, wherein the mount member and the clamp member are halves of a cylindrical pipe.

13. The expansion joint of claim 1, wherein the rigid seal plate includes a male-female coupler on circumferential ends thereof configured to mate with a circumferentially adjacent rigid seal plate.

14. The expansion joint of claim 1, further comprising a wire mesh seal member filling a gap between an adjacent duct flange, the clamp member, and the mount member.

15. The expansion joint of claim 1, wherein the rigid seal plate, the clamp member, and the mount member include a stainless steel.

16. An expansion joint for use between a turbine duct flange and a diffuser duct flange of a gas turbine exhaust system, the expansion joint comprising:
a plurality of arcuate expansion joint segments configured to be arranged collectively to form an annular expansion joint assembly, each arcuate expansion joint segment including:
a rigid seal plate having an inner radial end, an outer radial end, a through-hole extending through the inner radial end of the rigid seal plate, and a slot extending through the outer radial end of the rigid seal plate and open to a radial outer edge of the rigid seal plate;
a first pivot coupler pivotally coupling the inner radial end of the rigid seal plate to the turbine duct flange, the first pivot coupler including:
a first mount member fixedly coupled to the turbine duct flange and pivotally engaging a first axial side of the rigid seal plate,
a first clamp member pivotally engaging a second axial side of the rigid seal plate opposite the first axial side of the rigid seal plate, and
at least one first actuator including:
a first post fixedly coupled at one end thereof to the turbine duct flange and extending through a first opening in the first mount member, the through-hole in the inner radial end of the rigid seal plate, and a second opening in the first clamp member; and
a first force applicator operatively coupled to the first post and configured to force the first clamp member and the inner radial end of the rigid seal plate against the first mount member; and
a second pivot coupler pivotally coupling the outer radial end of the rigid seal plate to the diffuser duct flange, the second pivot coupler including:
a second mount member fixedly coupled to the diffuser duct flange and pivotally engaging the second axial side of the rigid seal plate,
a second clamp member pivotally engaging the first axial side of the rigid seal plate, and
at least one second actuator including:
a second post fixedly coupled at one end thereof to the diffuser duct flange and extending through a third opening in the second mount member, the slot in the outer radial end of the rigid seal plate, and a fourth opening in the second clamp member; and
a second force applicator operatively coupled to the second post and configured to force the second clamp member and the outer radial end of the rigid seal plate against the second mount member.

17. The expansion joint of claim 16, further comprising:
a first pair of post-interface seal plates at the outer radial end of the rigid seal plate, the first pair of post-interface seal plates including a first post-interface seal plate engaging the first axial side of the rigid seal plate between the rigid seal plate and the first mount member and a second post-interface seal plate engaging the second axial side of the rigid seal plate between the rigid seal plate and the first clamp member at the outer radial end of the rigid seal plate;
a second pair of post-interface seal plates at the inner radial end of the rigid seal plate, the second pair of post-interface seal plates including a third post-interface seal plate engaging the first axial side of the rigid seal plate between the rigid seal plate and the second clamp member and a fourth post-interface seal plate engaging the second axial side of the rigid seal plate between the rigid seal plate and the second mount member; or
both the first pair of post-interface seal plates and the second pair of post-interface seal plates.

18. The expansion joint of claim 16, wherein the rigid seal plate includes opposing circumferential ends configured to mate with an adjacent rigid seal plate of an adjacent arcuate expansion joint segment, and further comprises at least one segment end interface seal plate extending across a gap extending from the outer radial end to the inner radial end at adjacent circumferential ends of arcuately adjacent rigid seal plates, the at least one segment end interface seal plate engaging one of the first axial side and the second axial side of the arcuately adjacent rigid seal plates and including at least one fifth opening through which a respective post extends, wherein the fifth opening is smaller than the through-hole or the slot adjacent thereto in the rigid seal plate.

19. The expansion joint of claim 16, wherein the first and second mount members and the first and second clamp members are substantially hemispherical.

20. The expansion joint of claim 16, wherein in a cold operating state of the gas turbine exhaust system, the inner radial end of the rigid seal plate is axially forward of the outer radial end of the rigid seal plate, and in a hot operating state of the gas turbine exhaust system the inner radial end of the rigid seal plate is axially rearward of the outer radial end of the rigid seal plate.
